(19) United States
(12) Patent Application Publication
(10) Pub. No.: US 2015/0307962 A1
(43) Pub. Date: Oct. 29, 2015

(54) Novel Hydrogen-Evolving Polymer-Capped Aluminum Nanoparticles, Composites, and Methods of Synthesis Using Lithium Aluminum Hydride

(71) Applicant: Saint Louis University, St. Louis, MO (US)

(72) Inventors: Paul A. Jelliss, St. Louis, MO (US); Steven W. Buckner, St. Louis, MO (US); Brandon J. Thomas, St. Louis, MO (US)

(73) Assignee: Saint Louis University, St. Louis, MO (US)

(21) Appl. No.: 14/259,859

(22) Filed: Apr. 23, 2014

(51) Int. Cl. C22B 21/00; C01B 6/24; C10L 1/12; C22C 21/00; H01M 8/06; C01B 3/04; B22F 9/16

(52) U.S. Cl. CPC C22B 21/0015; C01B 3/04; C01B 6/243; B22F 9/16; C22C 21/00; H01M 8/065; C10L 1/12; C01P 2006/90; C01P 2004/64; C01P 2002/74; C10L 1/1208; C10L 1/1216; C10L 2200/0209; C10L 2200/0218; C10L 2270/04

(57) ABSTRACT

In some aspects, the present disclosure also provides new Al—Li₃AlH₆ nanocomposite materials, as well as methods of using LiAlH₄ to produce Al nanoparticles, Li₃AlH₆ nanoparticles, or Al—Li₃AlH₆ nanocomposite materials.

This invention was made with government support under Subrecipient Agreement No. RSC10011, Rev. No. 1; Prime Cooperative Agreement No. FA8650-10-2-2934 awarded by US Air Force Research Lab Nanoenergetics Program and CHE-0963363 awarded by the National Science Foundation. The Government has certain rights in the invention.

### BACKGROUND OF THE INVENTION

1. Field of the Invention

This disclosure relates to the fields of nanomaterials, fuel cells, and energetic materials. In particular, new nanomaterials, compositions, and methods of synthesis are provided as well as methods of use thereof.

2. Related Art

Nanoscale aluminum is known to have one of the highest energy densities of the reactive metals and has been widely used for energetic applications. Aluminum nanoparticles have been utilized in hybrid nanoenergetic formations, as a fuel additive, or as source of hydrogen gas production. Unfortunately, nanoparticles of aluminum are known to be highly reactive in ambient atmospheric conditions and in water. The reactivity of aluminum nanomaterials can be reduced by coating the surface of the nanoparticle with a polymerizable organic monomer. One such process is known as PIERMEN (Polymerization Initiation by Electron-Rich Metal Nanoparticles) and provides a barrier against the premature degradation or the rapid growth of the aluminum nanoparticles.

The production of Al nanoparticles is traditionally carried out by decomposing a base stabilized alane derivative with a titanium catalyst. The production of aluminum nanoparticles using alane is known to produce monodisperse particles which exhibit a narrow size distribution; however, production of the alane starting material is a prerequisite. Alanes though are costly to produce compared to other aluminum sources. Using wet chemical synthesis methods, lithium aluminum hydride has been used to reduce aluminum complexes (aluminum halides and organometallic complexes) and has also been shown to produce aluminum nanoparticles. With a bottom-up method wherein aluminum complexes are reduced, handling aluminum halides can be difficult as these starting materials are extremely hygroscopic and moisture sensitive. This reduction procedure also requires a high temperature (164° C.) to work. One of the best wet-chemical decomposition methods uses base-stabilized alane (AlH₃) as the precursor shown in U.S. Pat. No. 5,885,321, but this precursor is very expensive and very difficult to synthesize. Top-down degradation methods for making Al nanoparticles require the use of expensive equipment and require a large input of energy offsetting some of the benefits of the compounds. Finally, bimetallic nanoparticles have been produced using lithium aluminum hydride in the presence of titanium chloride through sonochemical methods. Unfortunately, this method does not produce single metal nanoparticles or nanoscale composites. Given the limitations of these methods, new methods of preparing aluminum nanoparticles and composites would be desirable. Such new methods may also result in the formation of new nanoparticles with unique properties.

### SUMMARY OF THE INVENTION

In some aspects, the present disclosure provides a nanomaterial comprising a homogenous mixture of lithium alanate nanoparticles comprising a nanoparticle core diameter between about 20 to about 40 nm and aluminum nanoparticles comprising a nanoparticle core diameter between about 15 and about 40 nm. In some embodiments, the nanomaterial comprises a powder X-ray diffraction pattern with a peak of highest intensity at about 2θ=38.4°. In some embodiments, the powder X-ray diffraction pattern further comprises peaks at about 2θ=21.9, 22.5, 31.7, 39.8, 44.7, 50.6, 51.5, 60.5, 61.4, 62.6, 65.1, 66.1, 78.2, and 82.4°. In some embodiments, the powder X-ray diffraction pattern is substantially as shown in FIG. 1. In some embodiments, the nanomaterial further comprises an alkyl polymer coating. In some embodiments, the polymer coating reduces the reactivity of the compound towards moisture. In some embodiments, the polymer coating crosslinks one or more nanoparticle cores. In some embodiments, the aluminum nanoparticles contain no amorphous aluminum oxide. In other embodiments, the aluminum nanoparticles contain less than 5% aluminum oxide. In other embodiments, the aluminum nanoparticles contain less than 1% aluminum oxide. In some embodiments, the aluminum nanoparticles with the polymer coating have a particle diameter of about 200 nm. In some embodiments, the aluminum nanoparticles and the lithium alanate nanoparticles comprise a ratio of aluminum nanoparticles to lithium alanate nanoparticles from about 1:4 to about 4:1. In some embodiments, the ratio is about 1:1.

In another aspect, the present disclosure provides a method of producing aluminum containing nanoparticles comprising: a) dissolving lithium aluminum hydride in a solvent; and b) admixing a titanium compound to the lithium aluminum hydride. In some embodiments, the method further comprises heating the solvent to a temperature from about 70° C. to about 100° C. In some embodiments, the temperature is about 85° C. In some embodiments, the solvent is heated to reflux. In some embodiments, the titanium compound is added after the solution has reached the temperature from about 70° C. to about 100° C. In some embodiments, the method further comprises heating the solution for a time period of about 1 minute to about 3 hours. In some embodiments, the time period is about 30 minutes. In some embodiments, the method is performed under an inert atmosphere. In some embodiments, the inert atmosphere is nitrogen gas or a noble gas. In some embodiments, the inert atmosphere is argon. In some embodiments, the method further comprises: c) adding a capping agent to the reaction. In some embodiments, the capping agent is an alkene_{(C≦30)}, substituted alkene_{(C≦30)}, an epoxide_{(C≦30)}, or a substituted epoxide_{(C≦30)}. In some embodiments, the capping agent undergoes polymerization to form a polymer coating on the nanoparticle. In some embodiments, the capping agent is an alkene_{(C≦30)}. In some embodiments, the alkene is alkene_{(C≦18)}. In some embodiments, the alkene is alkene_{(C≦14)}. In some embodiments, the alkene contains two or more carbon-carbon double bonds. In some embodiments, the capping agent is 1,7-octadiene, 1,9-decadiene, or 1,13-tetradecadiene. In some embodiments, the method comprises adding 0.1 equivalents of capping agent per equivalent of aluminum. In some embodiments, the solvent is an organic solvent. In some embodiments, the solvent is an ether_{(C≦12)}. In some embodiments, the solvent is tetrahydrofuran or diethyl ether. In some embodiments, the solvent is an arene_{(C≦12)}. In some embodiments, the solvent is toluene. In some embodiments, the solvent is a mixture of toluene and tetrahydrofuran. In some embodiments, the solvent is a mixture of toluene and diethyl ether. In some embodiments, the titanium compound is a titanium(IV) compound. In some embodiments, the titanium compound is a titanium(IV) tetraalkoxylate. In some embodiments, the titanium compound is titanium(IV) isopropoxide. In some embodiments, the method further comprises removing the solvent under vacuum. In some embodiments, the aluminum containing nanoparticles comprise a mixture of Al nanoparticles and Li₃AlH₆ nanoparticles. In some embodiments, the mixture comprises a ratio of Al nanoparticles to Li₃AlH₆ nanoparticles from about 5:1 to about 1:5. In some embodiments, the ratio is about 1:1. In some embodiments, the method further comprises separating the Al nanoparticles and the Li₃AlH₆ nanoparticles by rinsing with an alcohol_{(C≦12)}. In some embodiments, the nanocomposite is rinsed 1, 2, 3, 4, 5, 6, or more times. In some embodiments, the nanocomposite is rinsed 2, 3, 4, 5, or 6 times. In some embodiments, the alcohol_{(C≦12)} is methanol. In some embodiments, the alcohol_{(C≦12)} is at a temperature from about −95° C. to about 20° C. In some embodiments, the temperature is from about −20° C. to about 0° C. In some embodiments, the method further comprises passing the alcohol_{(C≦12)} through a filter. In some embodiments, the filter is a filter tube with a fritted disc. In some embodiments, the filter tube is essentially airfree. In some embodiments, the fritted disc is a medium porosity fritted disc. In some embodiments, the method further comprises drying the Al nanoparticles under vacuum. In some embodiments, the method further comprises removing the alcohol_{(C≦12)} from the Li₃AlH₆ nanoparticles and drying the nanoparticles under vacuum. In some embodiments, the nanoparticles comprise a core diameter of about 15 nm to about 45 nm. In some embodiments, the nanoparticles comprise a core diameter of about 20 nm to about 40 nm.

In yet another aspect, the present disclosure provides a method of using the nanomaterial or the nanoparticle of the present disclosure in a fuel cell. In some embodiments, the fuel cell is a hydrogen fuel cell. In some embodiments, the nanoparticle is used to generate hydrogen gas. In some embodiments, the nanomaterial is a mixture of Li₃AlH₆ nanoparticles and Al nanoparticles. In some embodiments, the mixture results in a primary and secondary hydrogen source.

In still another aspect, the present disclosure provides a method of adding the nanomaterial or the nanoparticles to a fuel to increase the energy content of the fuel. In some embodiments, the fuel is a liquid or a solid. In some embodiments, the fuel is a liquid. In some embodiments, the fuel is a solid. In some embodiments, the fuel is jet fuel.

In another aspect, the present disclosure provides a nanomaterial comprising one or more nanoparticles produced by: a) dissolving lithium aluminum hydride in a solvent; and b) admixing a titanium compound to the lithium aluminum hydride. In some embodiments, the method further comprises heating the solvent to a temperature from about 70° C. to about 100° C. In some embodiments, the temperature is about 85° C. In some embodiments, the temperature results in the solvent refluxing. In some embodiments, the titanium compound is added after the solution has reached the temperature from about 70° C. to about 100° C. In some embodiments, the method further comprises heating the solution for a time period of about 1 minute to about 3 hours. In some embodiments, the time period is about 30 minutes. In some embodiments, the method is performed under an inert atmosphere. In some embodiments, the inert atmosphere is nitrogen gas or a noble gas. In some embodiments, the inert atmosphere is argon. In some embodiments, the method further comprises: c) adding a capping agent to the reaction. In some embodiments, the capping agent is an alkene_{(C≦30)}, substituted alkene_{(C≦30)}, an epoxide_{(C≦30)}, or a substituted epoxide_{(C≦30)}. In some embodiments, the capping agent undergoes polymerization to form a polymer coating on the nanoparticle. In some embodiments, the capping agent is an alkene_{(C≦30)}. In some embodiments, the alkene is alkene_{(C≦18)}. In some embodiments, the alkene is alkene_{(C≦14)}. In some embodiments, the alkene contains two or more carbon-carbon double bonds. In some embodiments, the capping agent is 1,7-octadiene, 1,9-decadiene, or 1,13-tetradecadiene. In some embodiments, the method comprises adding 0.1 equivalents of capping agent per equivalent of aluminum. In some embodiments, the solvent is an organic solvent. In some embodiments, the solvent is an ether_{(C≦12)}. In some embodiments, the solvent is tetrahydrofuran or diethyl ether. In some embodiments, the solvent is an arene_{(C≦12)}. In some embodiments, the solvent is toluene. In some embodiments, the solvent is a mixture of toluene and tetrahydrofuran. In some embodiments, the solvent is a mixture of toluene and diethyl ether. In some embodiments, the titanium compound is a titanium(IV) compound. In some embodiments, the titanium compound is a titanium(IV) tetraalkoxylate. In some embodiments, the titanium compound is titanium(IV) isopropoxide. In some embodiments, the method further comprises removing the solvent under vacuum. In some embodiments, the aluminum containing nanoparticles comprises a mixture of Al nanoparticles and Li₃AlH₆ nanoparticles. In some embodiments, the mixture comprises a ratio of Al nanoparticles to Li₃AlH₆ nanoparticles from about 5:1 to about 1:5. In some embodiments, the ratio is about 1:1.

In another aspect, the present disclosure provides an Al nanoparticle produced by separating the Al nanoparticles from the Li₃AlH₆ nanoparticles in a nanomaterial of the present disclosure by rinsing with an organic solvent. In some embodiments, the organic solvent is a polar organic solvent. In some embodiments, the organic solvent is an alcohol_{(C≦12)}. In some embodiments, the nanocomposite is rinsed 1, 2, 3, 4, 5, 6, or more times. In some embodiments, the nanocomposite is rinsed 2, 3, 4, 5, or 6 times. In some embodiments, the alcohol_{(C≦12)} is methanol. In some embodiments, the organic solvent is at a temperature from about −95° C. to about 20° C. In some embodiments, the temperature is from about −20° C. to about 0° C. In some embodiments, the method further comprises passing the organic solvent through a filter. In some embodiments, the filter is a filter tube with a fritted disc. In some embodiments, the filter tube is essentially airfree. In some embodiments, the fritted disc is a medium porosity fritted disc. In some embodiments, the method further comprises drying the Al nanoparticles under vacuum. In some embodiments, the nanoparticles comprises a core diameter of about 15 nm to about 40 nm.

In yet another aspect, the present disclosure provides a Li₃AlH₆ nanoparticle produced by separating the Li₃AlH₆ nanoparticles from the Al nanoparticles in a nanomaterial of the present invention by rinsing with an organic solvent. In some embodiments, the organic solvent is a polar organic solvent. In some embodiments, the nanocomposite is rinsed 1, 2, 3, 4, 5, 6, or more times. In some embodiments, the nanocomposite is rinsed 2, 3, 4, 5, or 6 times. In some embodiments, the organic solvent is an alcohol_{(C≦12)}. In some embodiments, the alcohol_{(C≦12)} is methanol. In some embodiments, the organic solvent is at a temperature from about −95° C. to about 20° C. In some embodiments, the temperature is from about −20° C. to about 0° C. In some embodiments, the method further comprises passing the organic solvent through a filter. In some embodiments, the filter is a filter tube with a fritted disc. In some embodiments, the filter tube is essentially airfree. In some embodiments, the fritted disc is a medium porosity fritted disc. In some embodiments, the method further comprises removing the organic solvent from the Li₃AlH₆ nanoparticles and drying the nanoparticles under vacuum. In some embodiments, the nanoparticles comprises a core diameter of about 20 nm to about 40 nm.

It is contemplated that any method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.” The word “about” in the context of this application means within the standard error of the measurement or ±5% of the stated number. In some embodiments, the word “about” when used to describe a powder X-ray diffractions (PXRD) specta means that the value is equal to ±1° 2θ or as is defined above. In some embodiments, the value is equal to about ±0.5° 2θ.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description.

### BRIEF DESCRIPTION OF THE FIGURES

The following drawings form part of the present specification and are included to further demonstrate certain aspects of the present disclosure. The disclosure may be better understood by reference to one or more of these drawings in combination with the detailed description.

FIG. 1—Powder X-ray Diffraction (PXRD) pattern for nanomaterial produced through the decomposition of LiAlH₄ with Ti(OiPr)₄.

FIG. 2—(Top) Newly synthesized nanomaterial produced through the decomposition of LiAlH₄ with Ti(OiPr)₄ upon exposure to the ambient environment. (Bottom) The same nanomaterial after the 2-3 hours of exposure to the ambient environment.

FIG. 3—Powder X-Ray Diffraction (PXRD) pattern for fcc Al nanoparticle produced through the decomposition of LiAlH₄ in the presence of titanium and separated from the lithium alanate nanoparticles using cold methanol rinses and filtration.

FIG. 4—Powder X-Ray Diffraction (PXRD) pattern for material recovered from the methanol filtrate produced through the decomposition of LiAlH₄ in the presence of Ti(OiPr)₄ and separated from the fcc Al nanoparticles using cold methanol rinses and filtration.

FIG. 5—FTIR spectrum for organic polymer coated fcc Al nanoparticles. The spectrum contains no peaks corresponding to alkene bond motions from the starting polymeric coating polyolefin monomers.

FIG. 6—TEM images for the Al/Li₃AlH₆ nanocomposite prior to air exposure.

FIG. 7—FTIR spectrum for organic polymer coated Li₃AlH₆ nanoparticles. The spectrum contains no peaks corresponding to alkene bond motions from the starting polymeric coating polyolefin monomers.

FIG. 8—Electron diffraction pattern of Al/Li₃AlH₆ nanocomposite. The presence of both bright and diffuse rings indicates the homogeneity of the nanocomposite sample.

FIG. 9—DSC/TGA of Al/Li₃AlH₆ nanocomposite over a 2 hr. span with temperature held constant at 25° C.

FIG. 10—PXRD of Al/lithium alanate nanocomposite following air exposure and expansion. Peaks corresponding to fcc Al are located at 2θ=38.6°, 44.8°, 65.2°, 78.3°, and 82.5°.

### DESCRIPTION OF ILLUSTRATIVE EMBODIMENTS

The present disclosure provides a new method of preparing aluminum nanomaterials using lithium aluminum hydride solely as an aluminum source. These new methods produce a nanomaterial without relying on the expensive alane compounds traditionally used to prepare aluminum nanoparticles. Additionally, the instant method provides the production of Al/Li₃AlH₆ composites which can be separated into pure Al nanoparticles and Li₃AlH₆ compounds. These aluminum nanomaterials can be used in numerous high energy applications or for the generation of hydrogen through the decomposition of the material.

### I. ALUMINUM NANOPARTICLES

In one aspect of the present disclosure, the present disclosure provides nanoparticles produced by the method comprising:
a) dissolving lithium aluminum hydride in a solvent; and
b) admixing a titanium compound to the lithium aluminum hydride.

In some embodiments, the method further comprises heating the solvent to a temperature from about 70° C. to about 100° C. In some embodiments, the temperature is about 85° C. In some embodiments, the solvent is heated to reflux. In some embodiments, the titanium compound is added after the solution has reached the temperature from about 70° C. to about 100° C. In some embodiments, the method further comprises heating the solution for a time period of about 1 minute to about 3 hours. In some embodiments, the time period is about 30 minutes. In some embodiments, the method is performed under an inert atmosphere. In some embodiments, the inert atmosphere is nitrogen gas or a noble gas. In some embodiments, the inert atmosphere is argon. In some embodiments, the method further comprises adding a capping agent to the reaction. In some embodiments, the capping agent is an alkene_{(C≦30)}, substituted alkene_{(C≦30)}, an epoxide_{(C≦30)}, or a substituted epoxide_{(C≦30)}. In some embodiments, the capping agent undergoes polymerization to form a polymer coating on the nanoparticle. In some embodiments, the capping agent is an alkene_{(C≦30)}. In some embodiments, the alkene is alkene_{(C≦18)}. In some embodiments, the alkene is alkene_{(C≦14)}. In some embodiments, the alkene contains two or more carbon carbon double bonds. In some embodiments, the capping agent is 1,7-octadiene, 1,9-decadiene, or 1,13-tetradecadiene. In some embodiments, the method comprises adding 0.1 equivalents of capping agent per equivalent of aluminum. In some embodiments, the solvent is an organic solvent. In some embodiments, the solvent is an ether_{(C≦12)}. In some embodiments, the solvent is tetrahydrofuran or diethyl ether. In some embodiments, the solvent is an arene_{(C≦12)}. In some embodiments, the solvent is toluene. In some embodiments, the solvent is a mixture of toluene and tetrahydrofuran. In some embodiments, the solvent is a mixture of toluene and diethyl ether. In some embodiments, the titanium compound is a titanium(IV) compound. In some embodiments, the titanium compound is a titanium(IV) tetraalkoxylate. In some embodiments, the titanium compound is titanium(IV) isopropoxide. In some embodiments, the method further comprises removing the solvent under vacuum. In some embodiments, the aluminum containing nanoparticles comprises a mixture of Al nanoparticles and Li₃AlH₆ nanoparticles. In some embodiments, the mixture comprises a ratio of Al nanoparticles to Li₃AlH₆ nanoparticles from about 5:1 to about 1:5. In some embodiments, the ratio is about 1:1. In some embodiments, the method further comprising separating the Al nanoparticles and the Li₃AlH₆ nanoparticles by rinsing with an alcohol_{(C≦12)}. In some embodiments, the nanocomposite is rinsed 1, 2, 3, 4, 5, 6, or more times. In some embodiments, the nanocomposite is rinsed 2, 3, 4, 5, or 6 times. In some embodiments, the alcohol_{(C≦12)} is methanol. In some embodiments, the alcohol_{(C≦12)} is at a temperature from about −95° C. to about 20° C. In some embodiments, the temperature is from about −20° C. to about 0° C. In some embodiments, the method further comprising passing the alcohol_{(C≦12)} through a filter. In some embodiments, the filter is a filter tube with a fritted disc. In some embodiments, the filter tube is essentially airfree. In some embodiments, the fritted disc is a medium porosity fritted disc. In some embodiments, the method further comprises drying the Al nanoparticles under vacuum. In some embodiments, the method further comprises removing the alcohol_{(C≦12)} from the Li₃AlH₆ nanoparticles and drying the nanoparticles under vacuum. In some embodiments, the nanoparticles comprise a core diameter of about 15 nm to about 30 nm. In some embodiments, the nanoparticles comprise a core diameter of about 35 nm to about 55 nm.

Compounds of the disclosure may also have the advantage that they may be more efficacious than, cheaper to produce than, and/or have other useful physical or chemical properties over, compounds known in the prior art, whether for use in the manners stated herein or otherwise.

In addition, atoms making up aluminum nanoparticles, the Li₃AlH₆ nanocomposites, and aluminum nanocomposite materials are intended to include all isotopic forms of such atoms. Isotopes, as used herein, include those atoms having the same atomic number but different mass numbers. By way of general example and without limitation, isotopes of hydrogen include tritium and deuterium, and isotopes of carbon include ¹³C and ¹⁴C. Isotopes of lithium and aluminum are also contemplated in the compounds so long as the isotopes are stable.

### II. CAPPING OF ALUMINUM NANOPARTICLES TO MODULATE REACTIVITY

In some aspects of the present disclosure, the aluminum nanoparticles are capped using a variety of organic or inorganic compounds. In some embodiments, capping is achieved through the use of transition metal ions or the use of perfluoroalkylcarboxylic acids as shown by Foley, et al., 2005 and Jouet, et al., 2005, both of which are incorporated herein by reference. The use of polymers to act as a capping agent is also considered. In some embodiments, these organic polymers form a hydrophobic layer around the nanomaterial such that the polymer hinders the reactivity of the nanomaterial. In some aspects, capping the nanoparticles with an organic polymer hinders the formation of aluminum oxide leading to a more reactive nanomaterial. Without being bound by theory, the hydrophobic polymer may prevent reactive molecules such as water and oxygen from reaching the surface of the nanomaterial. In some embodiments, the nanoparticles are capped with alkyl-substituted epoxides. In some embodiments, these polymers are formed from the polymerization of polyolefins. In some embodiments, the polyolefin polymerization is catalyzed by the nanoparticle. In some embodiments, the polyolefin polymerization is thermally promoted. In some embodiments, the monomers for capping the nanomaterials are 1,7-octadiene, 1,9-decadiene, and 1,13-tetradecadiene. In some embodiments, any alkene containing at least two carbon carbon double bonds greater than 4 carbons and less than 30 carbons is envisioned as a monomer. In some embodiments, the alkene contains one or more carbon carbon double bonds which are terminal double bonds. In some embodiments, other polymers can be used to cap the nanomaterials so long as the polymer produces a hydrophobic layer around the resultant nanomaterial.

### III. HIGH ENERGY APPLICATIONS OF ALUMINUM NANOPARTICLES

Metallic aluminum has one of the highest combustion enthalpies (Dreizin, 2009). In some aspects of the present disclosure, the use of aluminum complexes and nanomaterials has been widely sought after to produce fuels or fuel additives containing higher energy content but the ease in which an aluminum oxide layer can form posses a major hurdle for their use. In particular embodiments of the present disclosure, nanoparticles are especially effective when added to fuel systems because the nanoparticles contain a significantly higher surface area leading to such favorable properties as shorter ignition delays, decreased burn times, and an increased and more complete combustion. Furthermore, in some embodiments, the addition of the nanoparticles enhances the physical properties of the material which result in more desirable properties for the fluids use as a fuel. In some embodiments, these compounds and compositions may be added to liquid and other solid fuels to increase the energy content of the fuel. The addition of aluminum materials into fuels to increase the energy content is taught by Gan and Qiao, 2010 and by Tyagi, et al., 2008, both of which are incorporated herein by references. In some embodiments, the aluminum compounds and compositions may be added to jet fuel to increase its energy content.

### IV. HYDROGEN EVOLUTION CAPACITY OF ALUMINUM NANOMATERIALS AND COMPLEXES

In some aspects of the present disclosure, metallic aluminum and aluminum nanomaterials and composites may be used to generate hydrogen gas for use in fuel cells or directly as a fuel. Without being bound by theory, it is believed that the decomposition of the starting material, LiAlH₄, goes through the following pathway of reactions (Dilts and Ashby, 1972, which is incorporate herein by reference):

LiAlH₄→Li₃AlH₆+2Al+3H₂ (I)

Li₃AlH₆→3LiH+Al+(3/2)H₂ (II)

2LiH+Al→2LiAl+H₂ (III) or

3LiH→3Li+(3/2)H₂ (IV)

In equation 1, the breakdown of lithium aluminum hydride generates both a lithium alanate and elemental aluminum with the byproduct being hydrogen gas. When the resultant compounds are broken down the lithium alanate can generate additional hydrogen gas not released during the initial breakdown of the lithium aluminum hydride. Furthermore, the aluminum nanoparticle can also react with water or moisture in the air to produce additional hydrogen gas. In some embodiments, the aluminum nanoparticles and the Li₃AlH₆—Al nanocomposites can be used to generate hydrogen both through a primary and a secondary source. In some embodiments, the hydrogen gas is produced over a longer period of time than either of those components individually.

### V. SYNTHETIC METHODS

In some aspects, the compounds of this disclosure can be synthesized using the methods of organic and organometallic chemistry as described in this application. These polymerization methods used to cap the nanoparticles can be further modified and optimized using the principles and techniques of organic chemistry as applied by a person skilled in the art. Such principles and techniques are taught, for example, in March's Advanced Organic Chemistry: Reactions, Mechanisms, and Structure (2007), which is incorporated by reference herein. The methods recited in this disclosure may be further modified and optimized using the principles and techniques of nanoparticle production as applied by a person of skill in the art which are taught, for example, in Nanostructures and Nanomaterials: Synthesis, Properties, and Applications by Cao and Wang, 2011, which is incorporated by reference herein.

### VI. DEFINITIONS

When used in the context of a chemical group: “hydrogen” means —H; “hydroxy” means —OH; “oxo” means ═O; “carbonyl” means —C(═O)—; “carboxy” means —C(═O)OH (also written as COOH or CO₂H); “halo” means independently —F, —Cl, —Br or —I; “amino” means —NH₂; “hydroxyamino” means —NHOH; “nitro” means —NO₂; imino means ═NH; “cyano” means CN; “isocyanate” means N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” means SH; and “thio” means ═S; “sulfonyl” means —S(O)₂—; and “sulfinyl” means —S(O)—.

In the context of chemical formulas, the symbol “-” means a single bond, “=” means a double bond, and “-” means triple bond. The symbol “----” represents an optional bond, which if present is either single or double. The symbol “ [symbol] ” represents a single bond or a double bond. Thus, for example, the formula

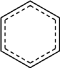

includes

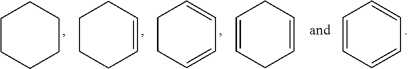

And it is understood that no one such ring atom forms part of more than one double bond. Furthermore, it is noted that the covalent bond symbol “-”, when connecting one or two stereogenic atoms, does not indicate any preferred stereochemistry. Instead, it cover all stereoisomers as well as mixtures thereof. The symbol “ [symbol] ”, when drawn perpendicularly across a bond (e.g.,

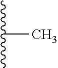

for methyl) indicates a point of attachment of the group. It is noted that the point of attachment is typically only identified in this manner for larger groups in order to assist the reader in unambiguously identifying a point of attachment. The symbol “ [symbol] ” means a single bond where the group attached to the thick end of the wedge is “out of the page.” The symbol “ [symbol] ” means a single bond where the group attached to the thick end of the wedge is “into the page”. The symbol “ [symbol] ” means a single bond where the geometry around a double bond (e.g., either E or Z) is undefined. Both options, as well as combinations thereof are therefore intended. The bond orders described above are not limiting when one of the atoms connected by the bond is a metal atom (M). In such cases, it is understood that the actual bonding may comprise significant multiple bonding and/or ionic character. Therefore, unless indicated otherwise, the formulas MC, M=C, M----C, and M [symbol] C, each refers to a bond of any and type and order between a metal atom and a carbon atom. Any undefined valency on an atom of a structure shown in this application implicitly represents a hydrogen atom bonded to that atom. A bold dot on a carbon atom indicates that the hydrogen attached to that carbon is oriented out of the plane of the paper.

When a group “R” is depicted as a “floating group” on a ring system, for example, in the formula:

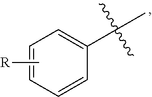

then R may replace any hydrogen atom attached to any of the ring atoms, including a depicted, implied, or expressly defined hydrogen, so long as a stable structure is formed. When a group “R” is depicted as a “floating group” on a fused ring system, as for example in the formula:

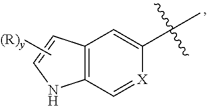

then R may replace any hydrogen attached to any of the ring atoms of either of the fused rings unless specified otherwise. Replaceable hydrogens include depicted hydrogens (e.g., the hydrogen attached to the nitrogen in the formula above), implied hydrogens (e.g., a hydrogen of the formula above that is not shown but understood to be present), expressly defined hydrogens, and optional hydrogens whose presence depends on the identity of a ring atom (e.g., a hydrogen attached to group X, when X equals —CH—), so long as a stable structure is formed. In the example depicted, R may reside on either the 5-membered or the 6-membered ring of the fused ring system. In the formula above, the subscript letter “y” immediately following the group “R” enclosed in parentheses, represents a numeric variable. Unless specified otherwise, this variable can be 0, 1, 2, or any integer greater than 2, only limited by the maximum number of replaceable hydrogen atoms of the ring or ring system.

For the groups and classes below, the following parenthetical subscripts further define the group/class as follows: “(Cn)” defines the exact number (n) of carbon atoms in the group/class. “(C≦n)” defines the maximum number (n) of carbon atoms that can be in the group/class, with the minimum number as small as possible for the group in question, e.g., it is understood that the minimum number of carbon atoms in the group “alkenyl_{(C≦8)}” or the class “alkene_{(C≦8)}” is two. For example, “alkoxy_{(C≦10)}” designates those alkoxy groups having from 1 to 10 carbon atoms. (Cn-n′) defines both the minimum (n) and maximum number (n′) of carbon atoms in the group. Similarly, “alkyl_{(C2-10)}” designates those alkyl groups having from 2 to 10 carbon atoms.

The term “saturated” as used herein means the compound or group so modified has no carbon-carbon double and no carbon-carbon triple bonds, except as noted below. In the case of substituted versions of saturated groups, one or more carbon oxygen double bond or a carbon nitrogen double bond may be present. And when such a bond is present, then carbon-carbon double bonds that may occur as part of keto-enol tautomerism or imine/enamine tautomerism are not precluded.

The term “aliphatic” when used without the “substituted” modifier signifies that the compound/group so modified is an acyclic or cyclic, but non-aromatic hydrocarbon compound or group. In aliphatic compounds/groups, the carbon atoms can be joined together in straight chains, branched chains, or non-aromatic rings (alicyclic). Aliphatic compounds/groups can be saturated, that is joined by single bonds (alkanes/alkyl), or unsaturated, with one or more double bonds (alkenes/alkenyl) or with one or more triple bonds (alkynes/alkynyl).

The term “alkyl” when used without the “substituted” modifier refers to a monovalent saturated aliphatic group with a carbon atom as the point of attachment, a linear or branched, cyclo, cyclic or acyclic structure, and no atoms other than carbon and hydrogen. Thus, as used herein cycloalkyl is a subset of alkyl, with the carbon atom that forms the point of attachment also being a member of one or more non-aromatic ring structures wherein the cycloalkyl group consists of no atoms other than carbon and hydrogen. As used herein, the term does not preclude the presence of one or more alkyl groups (carbon number limitation permitting) attached to the ring or ring system. The groups —CH₃ (Me), —CH₂CH₃ (Et), —CH₂CH₂CH₃ (n-Pr or propyl), —CH(CH₃)₂ (i-Pr, ⁱPr or isopropyl), —CH(CH₂)₂ (cyclopropyl), —CH₂CH₂CH₂CH₃ (n-Bu), —CH(CH₃)CH₂CH₃ (sec-butyl), —CH₂CH(CH₃)₂ (isobutyl), —C(CH₃)₃ (tert-butyl, t-butyl, t-Bu or ^{t}Bu), —CH₂C(CH₃)₃ (neo-pentyl), cyclobutyl, cyclopentyl, cyclohexyl, and cyclohexylmethyl are non-limiting examples of alkyl groups. The term “alkanediyl” when used without the “substituted” modifier refers to a divalent saturated aliphatic group, with one or two saturated carbon atom(s) as the point(s) of attachment, a linear or branched, cyclo, cyclic or acyclic structure, no carbon-carbon double or triple bonds, and no atoms other than carbon and hydrogen. The groups, —CH₂— (methylene), —CH₂CH₂—, —CH₂C(CH₃)₂CH₂—, —CH₂CH₂CH₂—, and

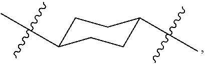 [SMILES: *C1CCC(*)CC1]

are non-limiting examples of alkanediyl groups. The term “alkylidene” when used without the “substituted” modifier refers to the divalent group ═CRR′ in which R and R′ are independently hydrogen, alkyl, or R and R′ are taken together to represent an alkanediyl having at least two carbon atoms. Non-limiting examples of alkylidene groups include: ═CH₂, ═CH(CH₂CH₃), and ═C(CH₃)₂. An “alkane” refers to the compound H—R, wherein R is alkyl as this term is defined above. An “epoxide” is an alkane as that term is defined above wherein a hydrogen atom on two adjacent carbons has been removed and replaced with a divalent oxygen such that the oxygen forms a three membered ring with the carbon chain. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —OC(O)CH₃, or —S(O)₂NH₂. The following groups are non-limiting examples of substituted alkyl groups: —CH₂OH, —CH₂Cl, —CF₃, —CH₂CN, —CH₂C(O)OH, —CH₂C(O)OCH₃, —CH₂C(O)NH₂, —CH₂C(O)CH₃, —CH₂OCH₃, —CH₂OC(O)CH₃, —CH₂NH₂, —CH₂N(CH₃)₂, and —CH₂CH₂Cl. The term “haloalkyl” is a subset of substituted alkyl, in which one or more hydrogen atoms has been substituted with a halo group and no other atoms aside from carbon, hydrogen and halogen are present. The group, —CH₂Cl is a non-limiting example of a haloalkyl. The term “fluoroalkyl” is a subset of substituted alkyl, in which one or more hydrogen has been substituted with a fluoro group and no other atoms aside from carbon, hydrogen and fluorine are present. The groups, —CH₂F, —CF₃, and —CH₂CF₃ are non-limiting examples of fluoroalkyl groups.

The term “alkenyl” when used without the “substituted” modifier refers to an monovalent unsaturated aliphatic group with a carbon atom as the point of attachment, a linear or branched, cyclo, cyclic or acyclic structure, at least one nonaromatic carbon-carbon double bond, no carbon-carbon triple bonds, and no atoms other than carbon and hydrogen. Non-limiting examples of alkenyl groups include: —CH═CH₂ (vinyl), —CH═CHCH₃, —CH═CHCH₂CH₃, —CH₂CH═CH₂ (allyl), —CH₂CH═CHCH₃, and —CH═CHCH═CH₂. The term “alkenediyl” when used without the “substituted” modifier refers to a divalent unsaturated aliphatic group, with two carbon atoms as points of attachment, a linear or branched, cyclo, cyclic or acyclic structure, at least one nonaromatic carbon-carbon double bond, no carbon-carbon triple bonds, and no atoms other than carbon and hydrogen. The groups, —CH═CH—, —CH═C(CH₃)CH₂—, —CH═CHCH₂—, and

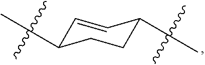 [SMILES: *C1C=CC(*)CC1]

are non-limiting examples of alkenediyl groups. It is noted that while the alkenediyl group is aliphatic, once connected at both ends, this group is not precluded from forming part of an aromatic structure. The terms “alkene” or “olefin” are synonymous and refer to a compound having the formula H—R, wherein R is alkenyl as this term is defined above. A “terminal alkene” refers to an alkene having a carbon-carbon double bond, wherein that bond forms a vinyl group at one end of the molecule. When any of these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —OC(O)CH₃, or —S(O)₂NH₂. The groups, —CH═CHF, —CH═CHCl and CH═CHBr, are non-limiting examples of substituted alkenyl groups.

The term “aryl” when used without the “substituted” modifier refers to a monovalent unsaturated aromatic group with an aromatic carbon atom as the point of attachment, said carbon atom forming part of a one or more six-membered aromatic ring structure, wherein the ring atoms are all carbon, and wherein the group consists of no atoms other than carbon and hydrogen. If more than one ring is present, the rings may be fused or unfused. As used herein, the term does not preclude the presence of one or more alkyl or aralkyl groups (carbon number limitation permitting) attached to the first aromatic ring or any additional aromatic ring present. Non-limiting examples of aryl groups include phenyl (Ph), methylphenyl, (dimethyl)phenyl, —C₆H₄CH₂CH₃ (ethylphenyl), naphthyl, and a monovalent group derived from biphenyl. The term “arenediyl” when used without the “substituted” modifier refers to a divalent aromatic group with two aromatic carbon atoms as points of attachment, said carbon atoms forming part of one or more six-membered aromatic ring structure(s) wherein the ring atoms are all carbon, and wherein the monovalent group consists of no atoms other than carbon and hydrogen. As used herein, the term does not preclude the presence of one or more alkyl, aryl or aralkyl groups (carbon number limitation permitting) attached to the first aromatic ring or any additional aromatic ring present. If more than one ring is present, the rings may be fused or unfused. Unfused rings may be connected via one or more of the following: a covalent bond, alkanediyl, or alkenediyl groups (carbon number limitation permitting). Non-limiting examples of arenediyl groups include:

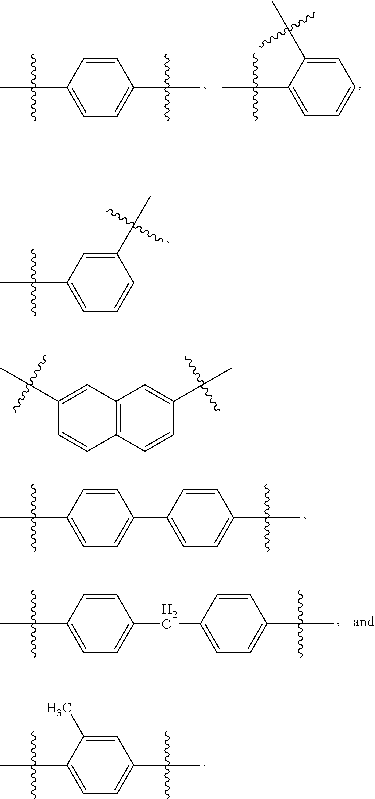

An “arene” refers to the compound HR, wherein R is aryl as that term is defined above. Benzene and toluene are non-limiting examples of arenes. When any of these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —OC(O)CH₃, or —S(O)₂NH₂.

The term “alkoxy” when used without the “substituted” modifier refers to the group —OR, in which R is an alkyl, as that term is defined above. Non-limiting examples of alkoxy groups include: —OCH₃ (methoxy), —OCH₂CH₃ (ethoxy), —OCH₂CH₂CH₃, —OCH(CH₃)₂ (isopropoxy), —OC(CH₃)₃ (tert-butoxy), —OCH(CH₂)₂, —O-cyclopentyl, and —O-cyclohexyl. The terms “alkenyloxy”, “alkynyloxy”, “aryloxy”, “aralkoxy”, “heteroaryloxy”, “heterocycloalkoxy”, and “acyloxy”, when used without the “substituted” modifier, refers to groups, defined as —OR, in which R is alkenyl, alkynyl, aryl, aralkyl, heteroaryl, heterocycloalkyl, and acyl, respectively. The term “alkoxydiyl” refers to the divalent group —O-alkanediyl-, —O-alkanediyl-O—, or -alkanediyl-O-alkanediyl-. The term “alcohol” corresponds to an alkane, as defined above, wherein at least one of the hydrogen atoms has been replaced with a hydroxy group. The term “ether” corresponds to an alkane, as defined above, wherein at least one of the hydrogen atoms has been replaced with an alkoxy group. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —OC(O)CH₃, or —S(O)₂NH₂.

In the context of this application, “essentially airfree” means that the atmosphere around the element is under a vacuum from about 800 mbar to about 0 mbar. In some particular embodiments, the vacuum is from about 100 mbar to about 0 mbar.

In the context of this application, “organic solvent” refers to a solvent which comprises at least one carbon atom. A “polar organic solvent” refers to a solvent which comprises a net dipole moment on at least one portion of the molecule or within one functional group attached to the molecule. In some embodiments, the organic solvent is selected from an alkane_{(C≦12)}, arene_{(C≦12)}, alcohol_{(C≦12)}, ether_{(C≦12)}, ester_{(C≦12)}, amide_{(C≦12)}, or a substituted version of any of these groups. In some embodiments, the organic solvent is selected from pentane, hexane, cyclohexane, acetonitrile, dichloromethane, chloroform, nitromethane, benzene, toluene, xylene, methanol, ethanol, isopropanol, tert-butanol, diethyl ether, tetrahydrofuran, ethyl acetate, dimethylformamide, or dimethylacetamide. In some non-limiting examples, acetonitrile, dichloromethane, chloroform, nitromethane, methanol, ethanol, isopropanol, tert-butanol, diethyl ether, tetrahydrofuran, dimethylformamide, ethyl acetate, or dimethylacetamide are polar organic solvents. In some embodiments, an aprotic polar organic solvent comprises acetonitrile, dichloromethane, chloroform, nitromethane, diethyl ether, tetrahydrofuran, ethyl acetate, dimethylformamide, or dimethylacetamide

The other abbreviations used throughout this application include Al NP, aluminum nanoparticles; NP, nanoparticles; iPr, isopropyl, M, molar; nm, nanometer; mL or ml, milliliter; μL, microliter; kV, kilovolt; and IR or FTIR, Fourier-transform infrared spectroscopy.

### V. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Materials and Methods

Reagents and Materials.

Lithium aluminum hydride (LiAlH₄, powder, reagent grade, 95%), titanium(IV) isopropoxide (99.999% trace metals basis), 1,7-octadiene (98%), 1,9-dec adiene (98%), 1,13-tetradecadiene (90%), toluene (anhydrous, 99.8%), tetrahydroforan (THF, anhydrous, ≧99.9%, inhibitor-free), and methanol (anhydrous, 99.8%) were all purchased from Sigma Aldrich. Anhydrous diethyl ether was purchased from J. T. Baker. Toluene and THF were distilled over sodium metal and potassium metal, respectively, to remove any trace oxygen and water. Diethyl ether and methanol were distilled over 4 Å molecular sieves. All alkenes were subjected to numerous freeze-pump-thaw cycles to remove any oxygen present. Titanium(IV) isopropoxide was dissolved in toluene to create a 0.0334M solution. Both LiAlH₄ and Ti(OiPr)₄ were stored under argon atmosphere to prevent oxygen/water exposure.

Synthesis.

All reactions were performed on a Schlenk line under argon atmosphere. LiAlH₄ (0.246 g, 6.48 mmol) was first added to a round-bottom Schlenk flask and dissolved in either THF or diethyl ether to create a 1.0 M solution. Following the addition of 20 mL toluene, the reaction mixture was heated to 85° C. using a J-KEM Model Apollo dual channel temperature controller. Upon reaching 85° C., 16 μL Ti(OiPr)₄ were added followed by the immediate addition of capping agent (octadiene, decadiene, or tetradecadiene; 10:1 Al:capping agent molar ratio). The reaction mixture was allowed to stir under reflux for 30 minutes, and all solvent was then removed in vacuo.

Separation of Lithium Alanate from Al.

The Al/Li₃AlH₆ mixture resulting from the synthesis was rinsed several times with cold methanol to prevent undesired oxidation of the Al NPs. The resulting slurry was filtered through an airfree filter tube equipped with a medium porosity fritted disc. Following filtration, the Al NPs were dried under vacuum, and all methanol was removed in vacuo from the alanate particles.

Powder X-Ray Diffraction.

All measurements were made using a Rigaku Miniflex 600 equipped with a Cu source operated at 40 kV and a scintillation counter detector. All assignments were made via comparison with the appropriate patterns from the ICDD Crystallographic Database.

Fourier-Transform Infrared Spectroscopy.

A Shimadzu model FTIR-8400S spectrometer equipped with an attenuated total reflectance (ATR) attachment was used to collect all data. All samples were dispersed in toluene prior to analysis.

Electron Microscopy.

TEM images and electron diffraction patterns were acquired using a Philips EM430ST operated at 300 kV, Samples were cast on Formvar grids. Image J software was used to estimate d-spacing values from the electron diffraction pattern.

Thermal Measurements.

All thermal measurements were collected using a TA Instruments SDT Q600 simultaneous DSC/TGA using alumina sample cups. Sample analysis was run from 25° C.-1200° C. with a heating rate of 10° C./min.

### Example 2

### Experimental Results

Al NPs are formed from the decomposition of LiAIH₄ in the presence of Ti(OiPr)₄ at 85° C. in either THF or diethyl ether. In addition to the Al NPs, lithium alanate, Li₃AIH₆, NPs are co-formed (˜50 weight % aluminum: lithium alanate NPs) in the LiAlH₄ decomposition reaction. Dienes, such as 1,7-octadiene, 1,9-decadiene, and 1,13-tetradecadiene, were used as passivating agents since the uncapped particles were pyrophoric in air.

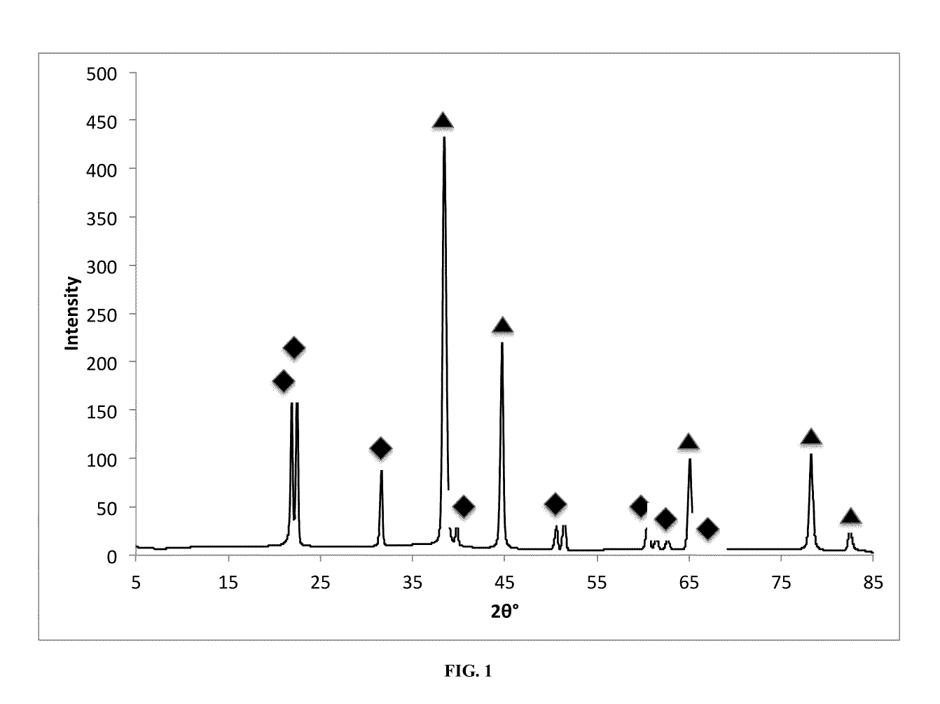

Powder X-ray diffraction (PXRD, FIG. 1) of the resulting grey powder shows the presence of 2 different phases in the resulting sample: face-centered cubic aluminum (fcc Al) and monoclinic lithium hexahydridoaluminate (Li₃AlH₆).

Estimated NP core sizes and d-spacings from PXRD analysis are presented in Table 1. The crystalline Al NP cores were ˜29 nm in diameter as determined from Scherrer analysis of the (111), (200), (220), and (331) diffraction peaks. The Li₃AlH₆ particles also appear to be nanocrystalline with NP core diameters between 23-36 nm. The estimated d-spacings are also in agreement with those reported for Li₃AlH₆ by Bastide et al., which is incorporated herein by reference. Elemental analysis of the nanocomposite using PDXL software provided by Rigaku indicates 51% by mass of the crystalline nanocomposite material is comprised of Al whereas the remaining 49% is comprised of Li₃AlH₆. These mass percentages are expected based on the stoichiometry presented in Reaction 1. These mass percentage values do not account for the presence of organic cap at the NP surface however.

TABLE 1
List of estimated crystalline core sizes and d-spacing
values for various lattice planes of fcc Al and monoclinic
Li₃AlH₆ as determined by PXRD.

| 2θ (°) | Miller Index | Crystalline Size (nm) | d-spacing (nm) |
|---|---|---|---|
| 21.9 | Li₃AlH₆ (110) | 36 | 0.406 |
| 22.5 | Li₃AlH₆ (012) | 35 | 0.395 |
| 31.7 | Li₃AlH₆ (202) | 32 | 0.282 |
| 38.4 | Al (111) | 20 | 0.234 |
| 39.8 | Li₃AlH₆ (104) | 33 | 0.226 |
| 44.7 | Al (200) | 28 | 0.202 |
| 50.6 | Li₃AlH₆ (13-2) | 28 | 0.180 |
| 51.5 | Li₃AlH₆ (12-4) | 28 | 0.177 |
| 60.5 | Li₃AlH₆ (21-5) | 23 | 0.153 |
| 61.4 | Li₃AlH₆ (32-2) | 36 | 0.151 |
| 62.6 | Li₃AlH₆ (11-6) | 28 | 0.148 |
| 65.1 | Al (220) | 28 | 0.143 |
| 66.1 | Li₃AlH₆ (404) | 34 | 0.141 |
| 78.2 | Al (311) | 32 | 0.122 |
| 82.4 | Al (222) | 35 | 0.117 |

Although lithium hydride (LiH) is a byproduct of the proposed breakdown of LiAlH₄, no LiH is observed via PXRD. While LiH is expected to have a fcc crystal lattice similar to that of the fcc Al, the diffraction pattern that can be observed closely aligns with that expected for fcc Al rather than LiH including exact d-space values corresponding to fcc Al and a strong (111) diffraction peak that is weak for LiH. Furthermore, LiAlH₄ is not observed in the diffraction pattern either, indicating complete conversion to the nanocomposite product.

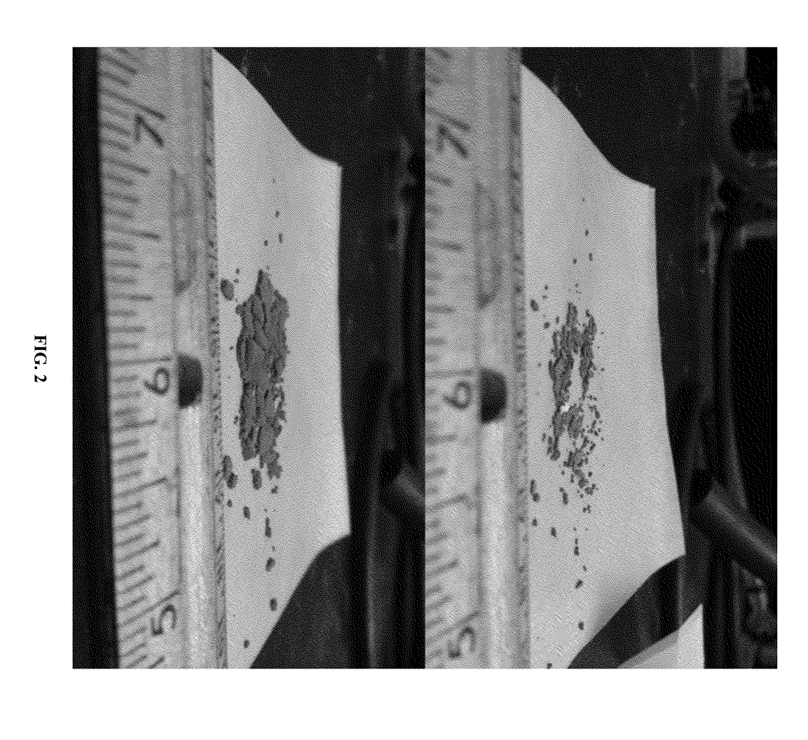

One feature of this material is its ability to expand in volume upon air exposure. Pre and post•air exposure photographs can be seen in FIG. 2. The gray solid originally obtained following the decomposition reaction transforms into a fine, homogenous gray powder over a 2-hr period. This “expansion” does not occur under inert atmosphere. Without being bound by theory, the cause of this expansion is believed to be related to the moisture in the ambient atmosphere causing gradual H₂ liberation over time. In addition, the expansion is only observed when diethyl ether is chosen as the solvent to initially dissolve LiAlH₄(s) prior to decomposition and not when THF is chosen. Without being bound by theory, a stable complex may be formed between the starting material, LiAlH₄, and the solvent, THF, which reduces the yield of the reaction (Ashby and James, 1969, which is incorporated herein by reference).

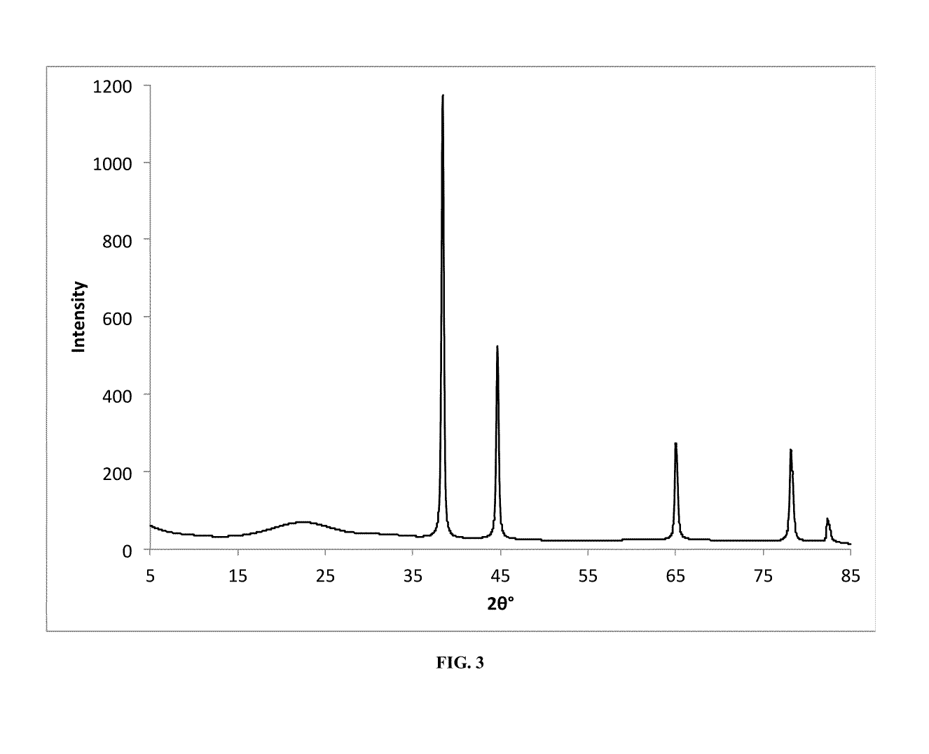

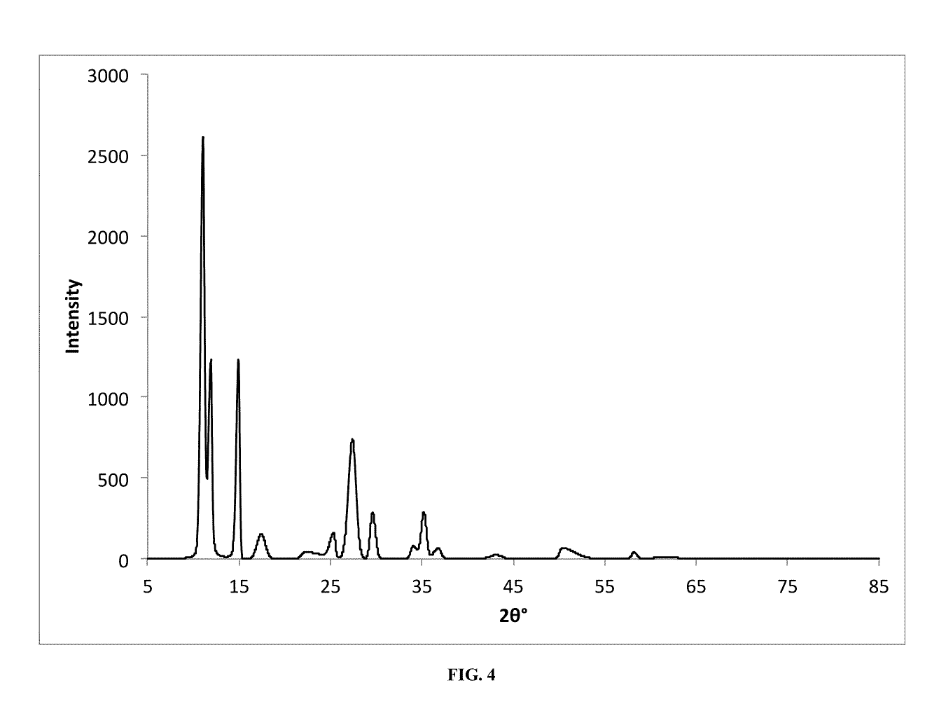

The Li₃AlH₆ NPs can be separated from the Al NPs with a cold methanol wash followed by filtration and removal of the methanol resulting in both pure Al NPs and pure Li₃AlH₆ NPs. The use of cold methanol to remove Li-containing components following Al NP production has been previously documented in the literature (See, examples in Haber and Buhro, 1998, Ghanta and Muralidharan, 2010, and Ghanta and Muralidharan, 2013, which are all incorporated herein by reference). The PXRD pattern seen in FIG. 3 was measured following the cold methanol wash and shows no evidence of LiAIH₄, Li₃AlH₆, or any other Li components: only fcc Al peaks are observed. In addition, PXRD for the separated lithium alanate nanomaterial following removal of solvent in vacuo (FIG. 4) shows no evidence of fcc Al or other potential lithium byproducts, indicative of a complete separation of the two nanocrystalline materials.

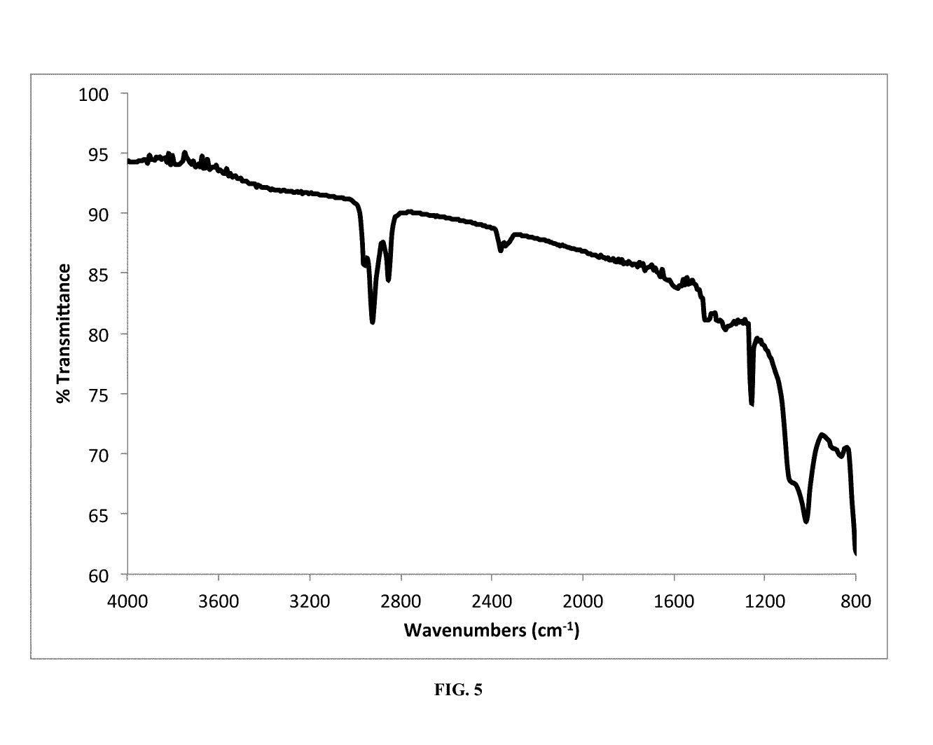

Using Fourier-transform infrared spectroscopy (FTIR) (FIG. 5), the presence of organic materials on the Al NP surface is seen as noted by the C—H stretching vibrations at ˜2970 cm⁻¹ and ˜2850 cm⁻¹. Since alkenes were chosen as the capping monomers for this material, C—H stretching vibrations are expected. The IR shows no evidence of C═C stretching supporting the conclusion that the reaction produced C═C polymerization thereby reducing the double bonds. PIERMEN when using alkenes as capping monomers for Al NPs prepared by alane decomposition has been observed (Thomas, et al., 2013, which is incorporated herein by reference).

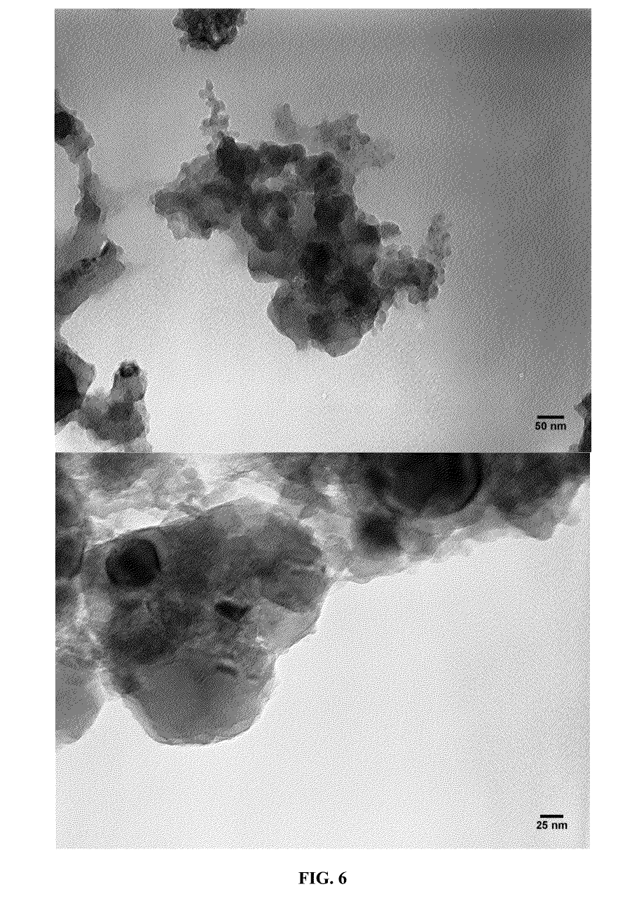

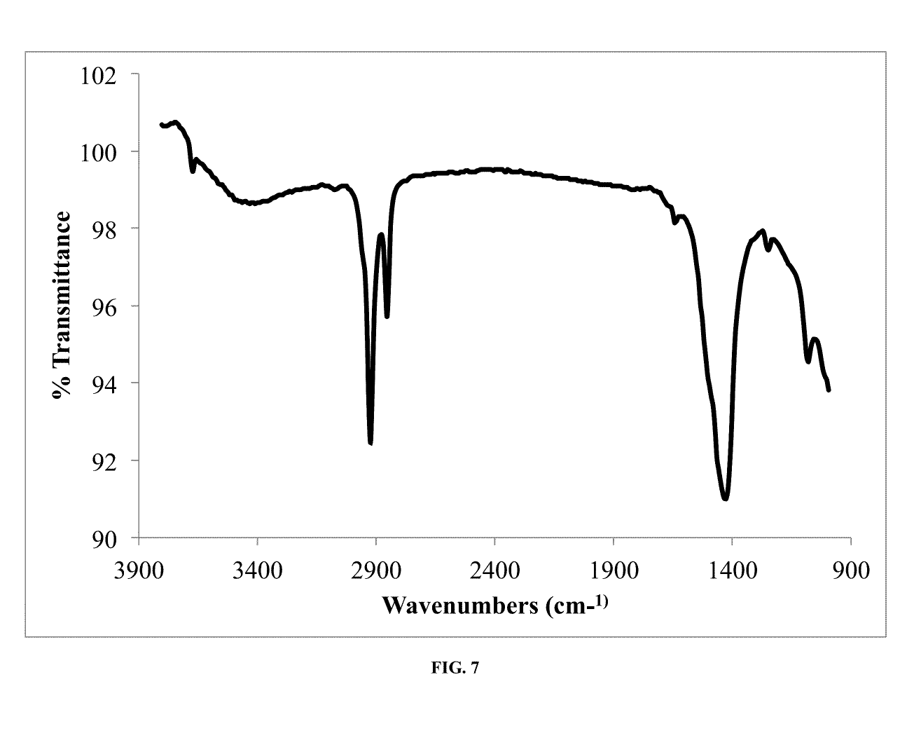

The TEM images (FIG. 6) indicate the particles are ˜20-60 nm in diameter. The particles also appear to be enveloped within a polymer matrix, which is a result of the chosen capping monomer, 1,7-octadiene. The crystalline NP cores are well protected by the cross-linked polymer layer, with no visible evidence of an amorphous Al oxide layer. The TEM images also reveal a fairly homogenous mixture of Al NPs and Li₃AlH₆ NPs. The less dense spherical particles observed in the TEM are most likely Li₃AlH₆ NPs. Spectroscopic data (FTIR) supports the presence of polymeric hydrocarbons on the alanate NP surface as well (sec FIG. 7).

TABLE 2
Estimate d-spacing values for the rings resulting from fcc Al

| Ring | d-spacing (nm) | Lattice Plane |
|---|---|---|
| 1 | 0.362 | Li₃AlH₆ (012) |
| 2 | 0.254 | Al (111) |
| 3 | 0.218 | Al (200) |
| 4 | 0.155 | Al (220) |
| 5 | 0.132 | Al (331) |

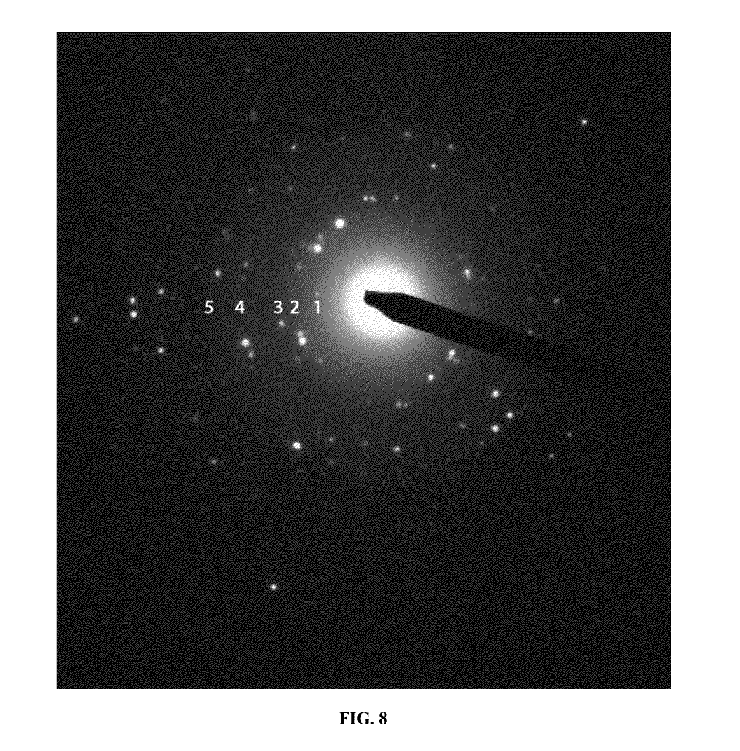

Similar observation was also noted in the obtained electron diffraction pattern shown in FIG. 8. Defined rings with d-spacings corresponding to those for fcc Al are clearly denoted. More diffuse rings are also visible; however, proper identification of these rings is difficult in this instance. Presumably, the diffuse rings are the result of monoclinic Li₃AlH₆. An estimated d-spacing value of 0.362 was calculated for the inner diffuse ring located closest to the electron beam (Ring 1). Without being bound by theory, the inner ring could be assigned to the (111) lattice plane of Li₃AlH₆; presumably, electron diffraction resulting from the (111) plane would be strongest. Although the diffuse rings cannot positively be identified, the extreme homogeneity of the nanocomposite is evident based on both the noticeable presence of multiple phases in both the electron diffraction patterns and in the TEM images.

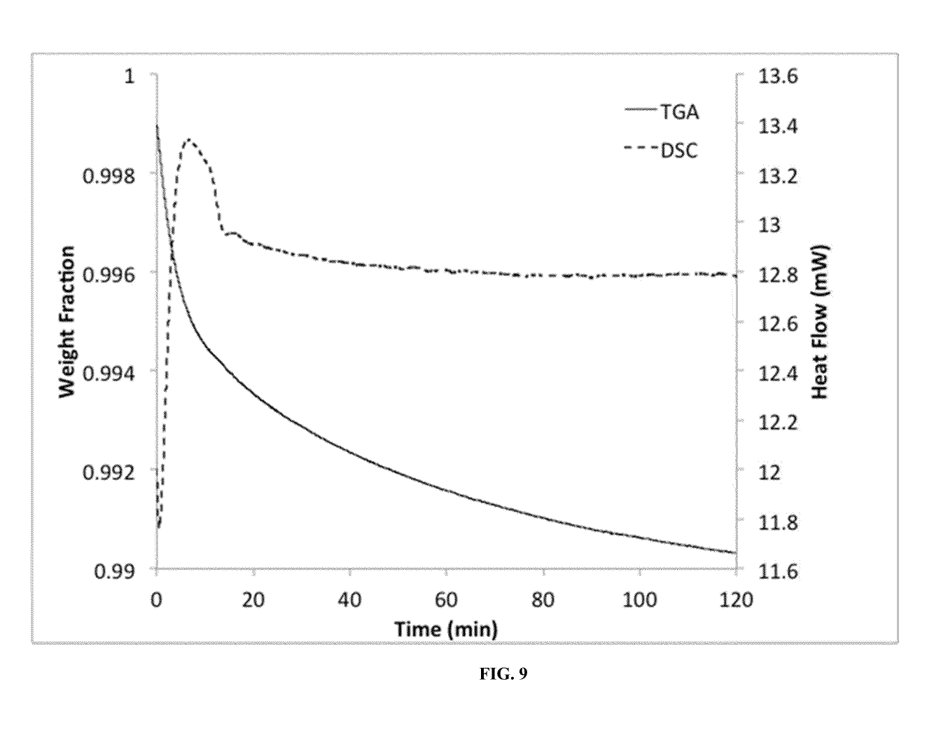

DSC/TGA was utilized to monitor the expansion phenomenon over a 2-hour time span (FIG. 9). For this study, the temperature was held constant at 25° C. for the entire two hours to mimic the environmental conditions. After 20 minutes, an exotherm was observed from the DSC profile, with an accompanying mass loss in the TGA curve. The total mass loss over this span equalled only 1%, which, provided that H₂ (g) is evolved, is not a completely unexpected as a result of the low molecular weight of H₂.

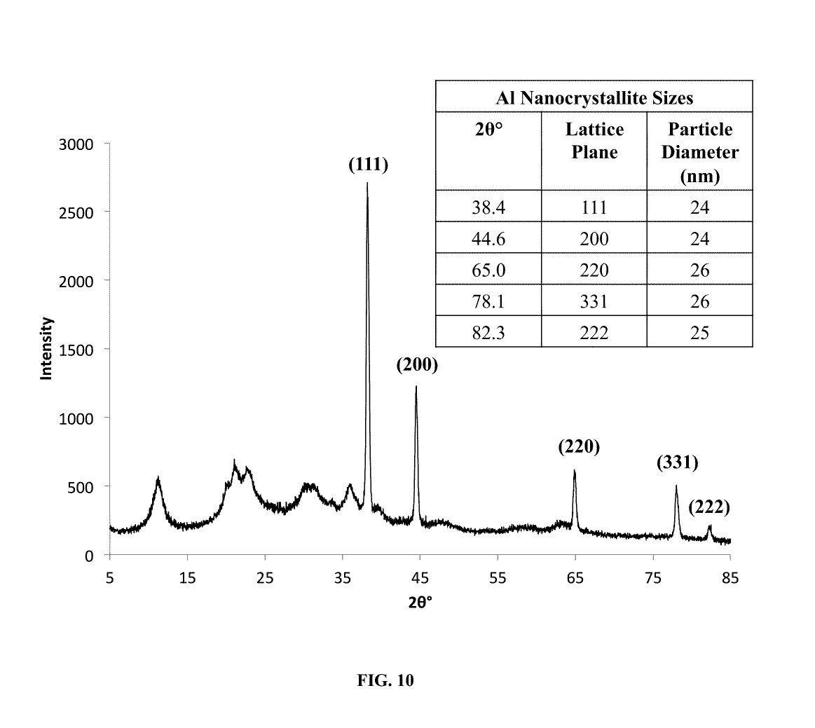

FIG. 10 shows the PXRD pattern of the Al/Li₃AlH₆ nanocomposite after the expansion event. Peaks for fcc Al are still present in the diffraction pattern, and Scherrer analysis shows minimal change in Al crystallite size. However, there are noticeable differences with regards to Li₃AlH₆. Many of the peaks observed for Li₃AlH₆ in the PXRD pattern of the nanocomposite prior to air exposure are no longer present in the PXRD pattern of the nanocomposite following air exposure: the peaks that are still present have shifted and broadened, indicating smaller crystallites are now present. Without being bound by theory, this change could indicate potential oxidation of the lithium alanate species by atmospheric moisture. Oxidation of the metallic Al NPs is possible as well; however, no evidence of Al oxide/hydroxide is present in the powder pattern. If oxides are present they are more than likely amorphous, an observation characteristic of oxide-passivated Al NPs.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### V. REFERENCES

The following references, to the extent that they provide exemplary procedural or other details supplementary to those set forth herein, are specifically incorporated herein by reference:
U.S. Pat. No. 5,885,321
Apperson, et al., J. Propul. Power, 25:1086-1091, 2009.
Ashby and James, Inorg. Chem. 8:2468-2472, 1969.
Aumann, et al., J. Vac. Sci. Technol. B., 13:1178-1183, 1995.
Balema, et al., J. Alloys Compd., 329:108-114, 2001.
Bastide, et al., Stud. Inorg. Chem., 3:785-788, 1983.
Bunker, et al., ACS Appl. Mater. Interfaces, 2:11-14, 2010.
Chen, et al., J. Phys. Chem. B, 105:11214-11220, 2001.
Chen, et al., Adv. Eng. Mater., 3:695-698, 2001.
Chung, et al., Langmuir, 25:8883-8887, 2009.
Dilts and Ashby, Inorg. Chem., 11:1230-1236, 1972.
Dreizin, Prog. Energy Combust. Sci., 35:141-167, 2009.
Epshteyn et al., Chem. Mater., 25:818-824, 2013.
Foley, et al., Chem. Mater. 17:4086-4091, 2005.
Ghanta and Muralidharan, Nanoscale, 2:976-980, 2010.
Ghanta and Muralidharan, J. Nanopart. Res., 15:1715-1724, 2013.
Haber and Buhro, J. Amer. Chem. Soc., 120:10847-10855, 1998.
Hammerstroem, et al., Inorg. Chem., 50:5054-5059, 2011.
Jelliss, et al., Solid State Sci., 23:8-12, 2013.
Jouet, et al., Chem. Mater. 17:2987-2996, 2005.
Mohan, et al., J. Nanopart. Res., 14:723-728, 2012.
Nanostructures and Nanomaterials: Synthesis, Properties, and Applications by Cao and Wang, World Scientific, 2011.
Shende, et al., Propellants, Explos., Pyrotech., 33:122-130, 2008.
Stamatis, et al., J. Propul. Power, 27:1079-1087, 2011.
Thiruvengadathan, et al., Combust. Flame, 158:964-978, 2011.
Thomas, et al., J. Nanopart. Res., 15:1729-1737, 2013.
Yetter, et al., Proc. Combust. Inst., 32:1819-1838, 2009.
Zhang, et al., MRS Online Proc. Libr., 1521:op1.2013.2130/2011-op1.2013.2130/2016, 2013

1. A nanomaterial comprising a homogenous mixture of lithium alanate nanoparticles comprising a nanoparticle core diameter from about 20 to about 40 nm and aluminum nanoparticles comprising a nanoparticle core diameter from about 15 to about 40 nm.

2. The nanomaterial of claim 1, wherein the nanomaterial comprises a powder x-ray diffraction pattern with a peak of highest intensity at about 38.4 ° 2θ.

3. The nanomaterial claim 1, wherein the powder x-ray diffraction pattern further comprises peaks at about 21.9, 22.5, 31.7, 39.8, 44.7, 50.6, 51.5, 60.5, 61.4, 62.6, 65.1, 66.1, 78.2, and 82.4° 2θ.

4. (canceled)

5. The nanomaterial of claim 1, wherein the nanomaterial further comprises an alkyl polymer coating.

6.-11. (canceled)

12. A method of producing aluminum containing nanoparticles comprising:
a) dissolving lithium aluminum hydride in a solvent; and
b) admixing a titanium compound to the lithium aluminum hydride.

13.-14. (canceled)

15. The method of claim 12, wherein the solvent is heated to reflux.

16.-18. (canceled)

19. The method of claim 12,
wherein the method is performed under an inert atmosphere.

20.-21. (canceled)

22. The method of claim 12, further comprising:
c) adding a capping agent to the reaction.

23. The nanomaterial of claim 22, wherein the capping agent is an alkene_{(C≦30)}, substituted alkene_{(C≦30)}, an epoxide_{(C≦30)}, or a substituted epoxide_{(C≦30)}.

24. The nanomaterial of claim 22, wherein the capping agent undergoes polymerization to form a polymer coating on the nanoparticle.

25.-28. (canceled)

29. The method of claim 23, wherein the capping agent is 1,7-octadiene, 1,9-decadiene, or 1,13-tetradecadiene.

30.-36. (canceled)

37. The method according to of claim 12, wherein the solvent is a mixture of toluene and diethyl ether.

38. (canceled)

39. The method of claim 12, wherein the titanium compound is a titanium(IV) tetraalkoxylate.

40. The method of claim 12, wherein the titanium compound is titanium(IV) isopropoxide.

41. (canceled)

42. The method of claim 12, wherein the aluminum containing nanoparticles comprises a mixture of Al nanoparticles and Li₃AlH₆ nanoparticles.

43.-44. (canceled)

45. The method of claim 42, further comprising separating the Al nanoparticles and the Li₃AlH₆ nanoparticles by rinsing with an alcohol_{(C≦12)}.

46.-58. (canceled)

59. A method of using the nanomaterial or the nanoparticle of claim 1 in a fuel cell or adding the nanomaterial or the nanoparticle to a fuel.

60. The method of claim 59, wherein the fuel cell is a hydrogen fuel cell.

61. The method of claim 59, wherein the nanoparticle is used to generate hydrogen gas.

62.-64. (canceled)

65. The method of claim 59, wherein the fuel is a liquid or a solid.

66.-129. (canceled)
